(19) United States
(12) Patent Application Publication
(10) Pub. No.: US 2012/0136830 A1
(43) Pub. Date: May 31, 2012

(54) MECHANISM FOR EFFICIENT DELAYED REPLICATION

(76) Inventor: Mikulas Patocka, Prague (CZ)

(21) Appl. No.: 12/956,944

(22) Filed: Nov. 30, 2010

(51) Int. Cl. G06F 7/00; G06F 17/00; G06F 17/30

(52) U.S. Cl. 707/637; 707/E17.001

(57) ABSTRACT

A mechanism for efficient delayed replication is described. A method of embodiments of the invention includes detecting input/output (I/O) requests issued by a software program running on a computer system, and sorting the I/O requests into I/O batches according to flight overlapping of the I/O requests. An I/O batch includes a set of flight-overlapped I/O requests of the I/O requests. The set of flight overlapped I/O requests includes two or more I/O requests that are issued, at least partially, in parallel. The method further includes replicating the I/O requests to a storage medium coupled to the computer system.

### TECHNICAL FIELD

The embodiments of the invention relate generally to data replication and, more specifically, relate to a mechanism for efficient delayed replication.

### BACKGROUND

Data replication is a well-known process for data sharing to ensure consistency between redundant software and/or hardware entities (e.g., storage devices), reliability, fault-tolerance, and preservation and protection of data. For example, data replication is initiated by a computer system at a primary site to store copies of data to multiple storage devices at secondary sites so that the data can be recovered in case of a failure (due to, for example, equipment failure, human act, natural disaster, etc.) of the computer system at the primary site. Using data replication, most of the data can be successfully stored at multiple storage devices, and the stored data can be quickly recovered from a storage device at a secondary site despite the failure of the computer system at the primary site. However, data replications are often slow and inefficient (such as due to large physical distance between primary and secondary sites) and therefore, often, large amounts of data are not replicated.

In case of delayed replication (the other one being immediate replication), it is common to have an acceptable amount of “fall behind” replication time. Fall behind replication time refers to an amount of time it takes for data to be replicated at a secondary site storage device after the data to be replicated has been issued and prompted for replication by a primary site computer system. For example, a 5 minute fall behind time means data can be 5 minutes late in getting replicated at a remote storage device after it has been committed for replication by a host computer system. Typically, fall behind time is set by a system administrator. However, on the one hand, if the fall behind time is set too small, the replicator may start to break data ordering or slow down the applications. On the other hand, if the fall behind time is too big, a remote site may be limited to having only data that is too old. Although it is acceptable to adopt a certain amount of fall behind replication time, under certain physical conditions and/or system limitations, the adopted fall behind time may not remain acceptable and can lead to inefficiency and data loss.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a host machine employing delayed replication mechanism according to one embodiment of the invention;

FIG. 2 illustrates delayed replication mechanism according to one embodiment of the invention;

FIG. 3A illustrates a graph illustrating flight overlapping of input/output requests according to one embodiment of the invention;

FIG. 3B illustrates a mechanism for writing a replication log according to one embodiment of the invention;

FIG. 3C illustrates a mechanism for facilitating a replication sequence based on the replication log of FIG. 3B according to one embodiment of the invention;

FIG. 4A illustrates a mechanism for facilitating a replication sequence based on the replication log of FIG. 3B according to one embodiment of the invention;

FIG. 4B illustrates a mechanism for facilitating a replication sequence based on the replication log of FIG. 3B according to one embodiment of the invention;

FIG. 5 illustrates a method for delayed replication according to one embodiment of the invention; and

FIG. 6 illustrates a computing system according to one embodiment of the invention.

### DETAILED DESCRIPTION

Embodiments of the invention provide a mechanism for efficient delayed replication. A method of embodiments of the invention includes detecting input/output (I/O) requests issued by a software program running on a computer system, and sorting the I/O requests into I/O batches according to flight overlapping of the I/O requests. An I/O batch includes a set of flight-overlapped I/O requests of the I/O requests. The set of flight overlapped I/O requests includes two or more I/O requests that are issued, at least partially, in parallel. The method further includes replicating the I/O requests to a storage medium coupled to the computer system.

In one embodiment, a delayed replication mechanism is provided to facilitate efficient replication of I/O requests to reduce the conventional fall behind replication time without compromising the integrity of the data contained within or associated with the I/O requests. The replication of I/O requests refers to committing or persisting I/O requests to one or more storage devices that may reside at remote secondary sites/locations, while the I/O requests are issued by one or more software applications running at a local/host computer system at a primary site/location. In one embodiment, the I/O requests are sorted into a number of I/O batches based on flight overlapping. In other words, two or more I/O requests that are issued, at least partially, in parallel or simultaneously are grouped together into an I/O batch. These I/O requests grouped in their corresponding I/O batches are then noted in a replication log. The distinction between two consecutive I/O batches is marked by a barrier. Then, in one embodiment, the I/O requests are replicated to one or more remote storage devices according to their sorted I/O batches so that an I/O request of an I/O batch can be replicated without having to wait for a confirmation response, from the target storage device, for a previously-replicated I/O request within that I/O batch.

In another embodiment, a barrier request is inserted between two consecutive I/O batches, distinguishing the two I/O batches, while an ordered tag may be assigned to a first or last I/O request of an I/O batch. In this case, the target storage device can directly detect and identify each barrier request or ordered tag and its corresponding I/O batch so that I/O requests can be replicated without the host computer system having to wait for confirmation responses for any of the previously-replicated I/O requests regardless of their associated I/O batches. Embodiments of the invention provide efficient delayed replication that significantly reduces the conventional fall behind time without compromising data integrity and consequently, more data is preserved and can be recovered in case of a failure (e.g., due to, for example, equipment failure, human act, natural disaster, etc.) with the host computer system at the primary site.

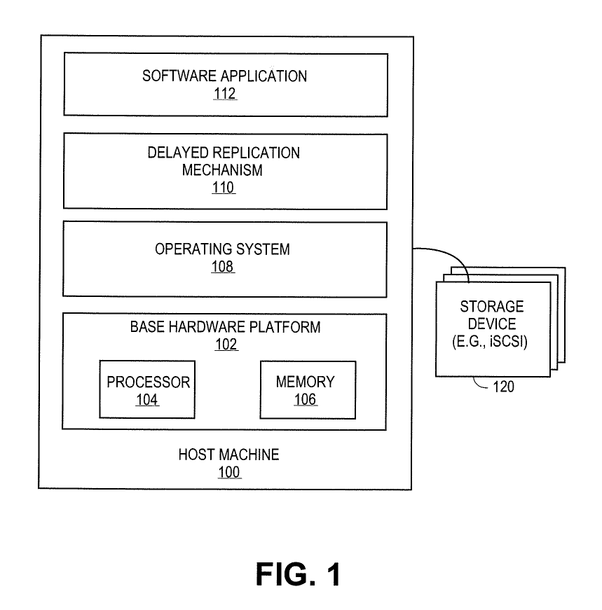

FIG. 1 illustrates a host machine 100 employing delayed replication mechanism 110 according to one embodiment of the invention. Host machine 100 includes a base hardware platform 102 that comprises a computing platform, which may be capable, for example, of working with a standard operating system 108. Operating system 108 serves as an interface between any hardware or physical resources of the host machine 100 and a user. In some embodiments, base hardware platform 102 may include a processor 104, memory devices 106, network devices, drivers, and so on. Host machine 100 may include a server computing system or a client computing system. Further, terms like “machine”, “device”, “computer”, and “computing system” are used interchangeably and synonymously throughout this document.

In one embodiment, the host machine 100 employs delayed replication mechanism 110 to perform delayed replication of input/output (“I/O”) requests (also referred to as “data blocks”, “I/O operation”, “BIO”, or simply “I/O”) (e.g., write I/O request) at one or more storage devices 120 in communication with the host machine 100. The delayed replication mechanism 110 may (or may not) be part of the operating system 108. An I/O request is issued by software application 112 and refers to a memory-mapped I/O that is used to access hardware by writing (and reading) to specific memory locations.

Software application 112 running at the host machine 100, located at a primary site or location, issues a number of I/O requests and calls for their commitment to remote storage devices 120, located at various secondary sites or locations. In one embodiment, the delayed replication mechanism 110 receives this call and sorts the I/O requests into a number of I/O batches which are then efficiently replicated at the remote storage devices 120. Some embodiments of efficient replication will be further discussed in reference to the subsequent figures. A storage device 120 may include a network storage device, such as a storage area network (“SAN”) device, a network-attached storage (“NAS”) device, an Internet Small Computer System Interface (“iSCSI”), or the like. Further, a storage device 120 may run special software that communicates with the primary site (of the host machine 100) in proprietary tool. Further, any amount of distance between primary and secondary sites is contemplated; for example, in case of multiple storage devices 120 located at multiple secondary sites, a primary site where the host machine 100 resides may be located next door to one of the secondary sites while being several thousand miles away from another secondary site.

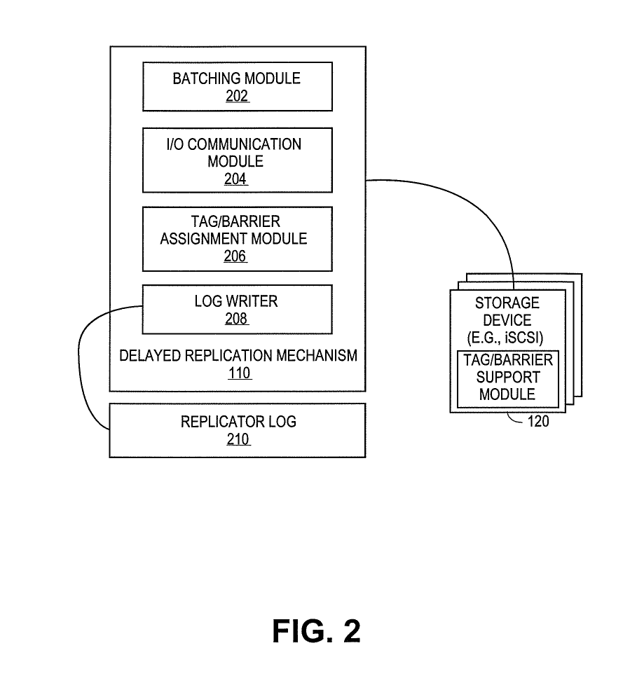

FIG. 2 illustrates delayed replication mechanism 110 according to one embodiment of the invention. In one embodiment, delayed replication mechanism 110 performs efficient delayed replication of I/O requests issued by one or more software applications running on a host machine wherein the delayed replication mechanism 110 is also employed.

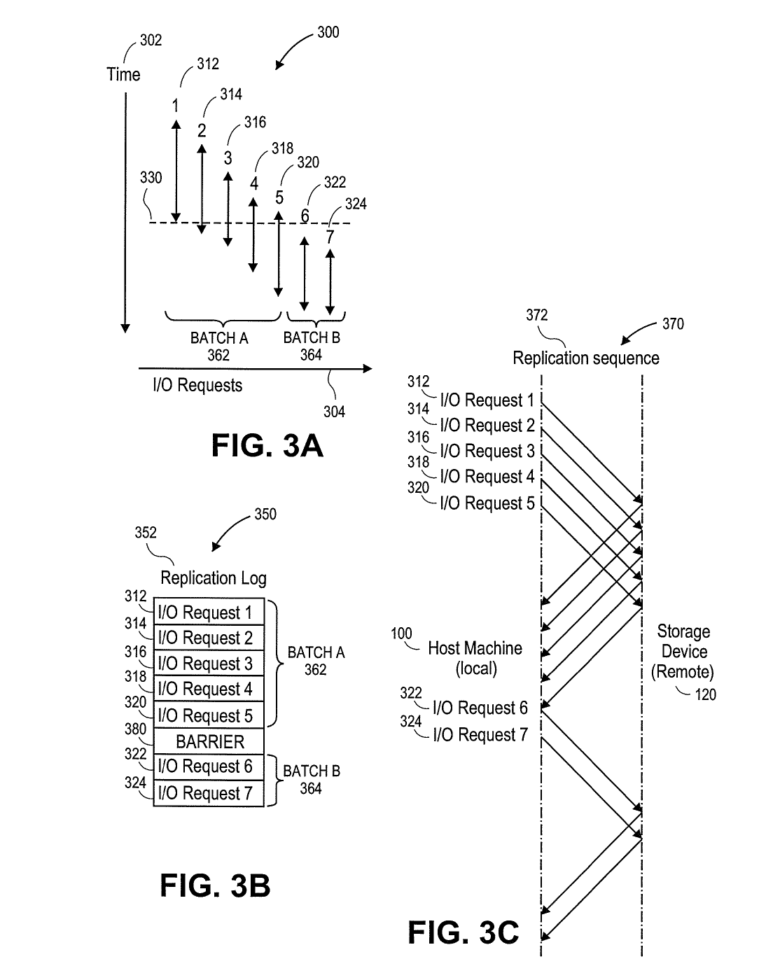

In one embodiment, the delay replication mechanism 110 includes a batching module 202, an I/O communication module 204, a tag/barrier assignment module 206, and a log writer 208. Upon issuance of I/O requests and their call for commitment by one or more software applications running on the host machine, the batching module 202 of the delayed replication mechanism 110 receives the I/O requests and detects various sets of two or more I/O requests with overlapping flights. For example, once the process of issuing a first I/O request has started, the batching module 202 detects every other I/O request that has started to issue during the issuance process of the first I/O request. This process is referred to as “flight overlapping”. In this case, these other I/O requests that are subsequently issued are regarded as flight overlapping with the first I/O request. The detected I/O requests are then sorted by the batching module 202 into a first I/O batch with, in this case, the first I/O request being the leading or primary I/O request. Similarly, the batching module 202 generates a second I/O batch having a second I/O request as the primary I/O request of that I/O batch while detecting and noting a barrier between the first I/O batch and the second I/O batch. A barrier is detected when all flight-overlapped I/O requests to a primary I/O request (e.g., the first I/O request) have been detected and a NULL is encountered by the batching module 202 before detecting another primary I/O request (e.g., the second I/O request) and its flight-overlapped I/O requests. The batching module 202 continues to generate similar I/O batches including other sets of flight overlapped I/O requests lead by a primary I/O request. This will be further illustrated with reference to FIGS. 3A-3C.

Regarding the start of an I/O request (process), consider software (e.g., a file system or an application) running on a computer system constructs an I/O request and calls an operating system function to submit the I/O request; the software's calling of the function is considered starting of the I/O request. Regarding the end of an I/O request (process), consider an operating system notifies the software that the I/O request has been completed and returns a status (e.g., error notification, success notification, and possibly, but not necessarily, how much data has been transferred, etc.). The notification can be done with a callback (when the software says “call this function when the I/O request is finished” and the operating system calls that function when the I/O request is finished), by a thread unblocking (when the software says “I want to wait until the I/O request is finished” and the operating system doesn't run the thread, until then), by a flag (when the operating system sets a flag somewhere in memory indicating that the I/O request is complete) or by some other method. Between the start and the end of the I/O request, the operating system owns the I/O request, it routes the I/O request to an appropriate device driver (e.g., a replicator driver in this case) and passes the I/O request to the driver. The replicator driver then writes the request to the log, and when the write to the log is finished and committed, the I/O request is returned to the operating system, which notifies the software about the end of the I/O request.

Once an I/O batch including two or more I/O requests is formed, the log writer 208 registers or notes the batch information into a replicator log 210. The log writer 208 writes the I/O requests to the replicator log 210 immediately as the I/O requests come in without having to wait for an I/O batch to form (although, it could wait until then). In one embodiment, the log writer 208 writes an entry for each I/O request that is detected and inserts a barrier between two consecutive I/O batches of I/O requests issued at different times, such as each of the two consecutive I/O batches having its own flight overlapped I/O requests that are issued at a different time than the flight-overlapped I/O requests of the other I/O batch. For example, a barrier may include a mark, a character, a tag or a flag of some type representing the start and/or the end of each I/O batch. Using the I/O communication module 204, these I/O batches are then committed or replicated to various remote storage devices 120. Using I/O batches to replicate I/O requests, the strict replication order of the I/O requests, within each I/O batch, may not be as important to follow which allows for a much faster out-of-order replication without compromising the integrity of the data that is being replicated through the I/O requests. For example, the host machine does not have to wait for a storage device 120 to return a commitment response for each I/O request before another I/O request within that I/O batch can be replicated at that storage device 120. An I/O batch may contain a single I/O request. For example, if the application behaves in such a way that it “sends one request-waits for it to finish-sends the second request-waits for it to finish-etc.”, then there may be I/O batches containing one I/O request. Most applications, typically, send a number of I/O requests in parallel, so I/O batching is performed. is possible.

The log writer 208, in one embodiment, operates as follows: I/O request 1 comes in and is started to be written to the replication log 210; I/O request 2 comes in and is started to be written to the replication log 210; I/O request 3 comes and is started to be written to the replication log 210; I/O request 4 comes in and is started to be written to the replication log 210; I/O request 5 comes in and is started to be written to the replication log 210; and at this point, the write of I/O request 1 to the replication log 210 is finished. I/O request 1 is reported as finished to the application and a batch of requests 1, 2, 3, 4, and 5 is formed. Then, the write of I/O request 2 to the replication log 210 is finished, and I/O request 2 is reported as finished to the application. Meanwhile, I/O request 6 comes in and is started to be written to the replication log 210 (and, this way, I/O request 6 now becomes the first I/O request of the new batch), and so forth. In another embodiment, the log writer 208 actively tries to predict when more I/O requests would come in and waits for the I/O requests to form an I/O batch.

In one embodiment, a storage device 120 includes a tag/barrier support module 220 having the ability to recognize barrier requests and ordered tags that are inserted and assigned, respectively, by the tag/barrier assignment module 206 residing at the host machine. Unlike a barrier that is noted in the replicator log 210, in this embodiment, a barrier request is inserted between two consecutive I/O batches to distinguish one I/O batch of flight-overlapped I/O requests from another I/O batch of flight-overlapped I/O requests; nevertheless, such barrier requests are inserted based on the corresponding barriers noted in the replicator log 210. Similarly, an ordered tag is assigned to the first I/O request or the last I/O request of each I/O batch to distinguish it from other consecutive I/O batches. Using the tag/barrier support module 220, these inserted barrier requests and assigned ordered tags can be directly identified by the storage devices 120 and this way, in one embodiment, I/O requests can be replicated without having to wait for a commitment response, from the storage devices 120, for any of the I/O requests regardless of the corresponding I/O batch.

FIG. 3A illustrates a graph 300 illustrating flight overlapping of I/O requests 312-324 according to one embodiment of the invention. In the illustrated graph 300, I/O requests 304 are shown as being issued (e.g., start issue, end issue) versus time 302 with the dotted line 330 representing the cut off line where the first I/O batch A 362 ends and the second I/O batch B 364 starts. For example, as illustrated, I/O requests 2-5 314-320 at least begin (as indicated by their upward arrows above the dotted line 330) before the issuance process of I/O request 1 312 ends (as indicated by its downward arrow above the dotted line 330) and therefore, I/O requests 1-6 312-320 are considered flight-overlapped and sorted into a single I/O batch A 362 with I/O request 1 312 serving as its primary I/O request. Similarly, I/O requests 6-7 322-324 (shown below the dotted line 330) are also considered flight-overlapped and sorted into another I/O batch B 364 with I/O request 6 322 acting as its primary I/O request. The dotted line 330 is used to simply illustrate a division line or separation between the two I/O batches A 362 and B 364 for brevity, simplicity and ease of understanding.

FIG. 3B illustrates a mechanism 350 for writing a replication log 352 according to one embodiment of the invention. In one embodiment, the I/O requests 312-324 are registered in the replication log 352 in a particular order having a barrier 380 separating the two I/O batches A 362 (including I/O requests 1-5 312-320) and B 364 (including I/O requests 6-7 322-324) as determined based on flight overlapping as shown in FIG. 3A. In one embodiment, delayed replication mechanism detects I/O request 1 312 and notes it as a primary I/O request in the replication log 352 and then continues to detect its flight-overlapped I/O requests 2-5 314-320 until it encounters a gap or NULL which represents the barrier 380. At this point, I/O batch A 362 is formed. Subsequent to the barrier 380, the detection process restarts when the next (primary) I/O request (e.g., I/O request 6 322) is detected followed by its flight-overlapped I/O request 7 324. The process continues with forming I/O batch B 364.

FIG. 3C illustrates a mechanism 370 for facilitating a replication sequence 372 based on the replication log 352 of FIG. 3B according to one embodiment of the invention. In one embodiment, a replication sequence 372 is facilitated based on the entries of the replication log 352. In one embodiment, I/O requests 1-5 312-320 are communicated, from host machine 100 to storage devices 120, one-by-one without the host machine 100 having to wait for a commitment response, from the storage devices 120, for any of the I/O requests 1-5 312-320. For example, I/O request 5 320 is replicated at the storage devices 120 without the host machine having to receive a commitment response for any of the previously-replicated I/O requests 1-4 312-318. Similarly, I/O request 7 324 is replicated at the storage devices 120 without having to wait for a commitment response for the previously-replicated I/O request 6 322. Being able to replicate I/O requests 1-5 312-320 and 6-7 322-324 by I/O batches A 362 and B 364, respectively, without having to wait for commitment responses significantly lowers the fall behind replication time without corrupting the replicated data.

I/O requests 1-7 312-324 are shown as being replicated in a particular order based on their I/O batches A-B 362-364 and as provided in the replication log 352; however, to achieve even higher efficiency and lower fall behind time, in one embodiment, I/O requests 1-7 312-324 may be replicated out-of-order within their respective I/O batches A-B 362-364. For example, I/O request 5 320 of I/O batch A 362 may be replicated before I/O request 3 316 of I/O batch A 362.

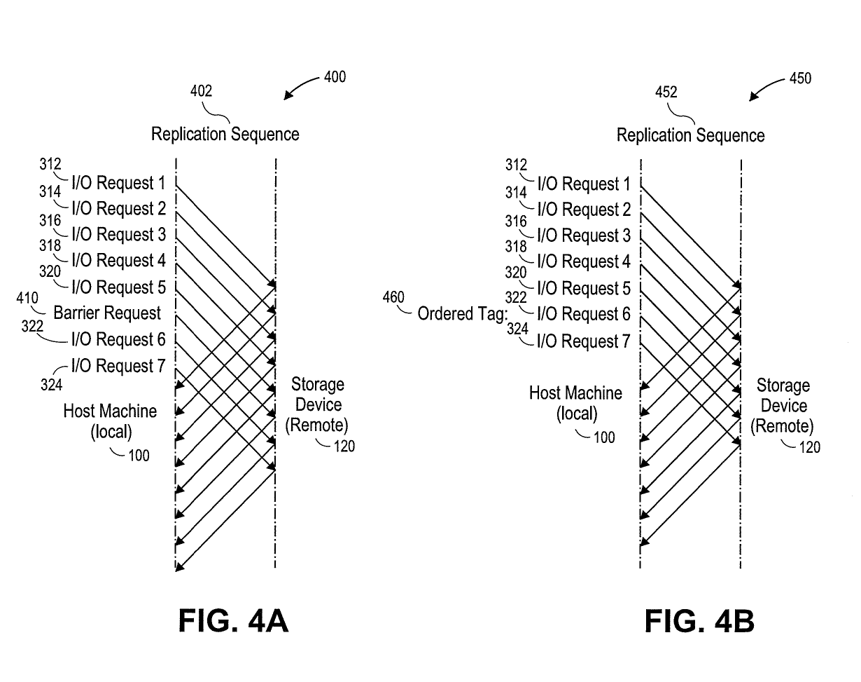

FIG. 4A illustrates a mechanism 400 for facilitating a replication sequence 402 based on the replication log 352 of FIG. 3B according to one embodiment of the invention. In one embodiment, I/O requests 1-5 312-320 of I/O batch A 362 and I/O requests 6-7 322-324 of I/O batch B 364, issued by a local host machine 100, are replicated at a remote storage device 120 in an order or sequence that is independent of its corresponding I/O batch 362, 364 and whether a commitment response has been received for any of the preceding I/O requests. For example, distinct from the transaction sequence 372 of FIG. 3C, here, even the I/O requests 6-7 322-324 of I/O batch B 364 are replicated prior to receiving commitment responses for any of the I/O requests 1-5 312-320 of I/O batch A 362. The two I/O batches A-B 362-364 are distinguished using a barrier request 410 that is inserted between (the last) I/O request 5 320 of (the first) I/O batch A 362 and (the first) I/O request 6 322 of (the second) I/O batch B 364. This barrier request 410, in one embodiment, is directly identified by the tag/barrier support module of the storage medium 120, as discussed with reference to FIG. 2, which allows for the replication process to proceed much faster with greater efficiency and lower fall behind time.

FIG. 4B illustrates a mechanism 450 for facilitating a replication sequence 452 based on the replication log 352 of FIG. 3B according to one embodiment of the invention. The illustrated replication sequence 452 is similar in operation to the replication sequence 402 of FIG. 4A, except, in this embodiment, an ordered tag 460 is assigned to (the first) I/O request 6 322 of I/O batches B 364 to distinguish it from the previous I/O batch A 362. In another embodiment, the ordered tag 460 may be assigned to the last I/O request, such as I/O request 1 312 of I/O batch A 362 and I/O request 7 324 of I/O batch B 364. The ordered tag 460 serves the same purpose as the barrier request 410 but may be different in form or type from the barrier request 410 in that the ordered tag 460 (e.g., a mark, a tag, a flag, etc.) may be chosen and/or designed by the barrier/tag support module employed at the storage device 120.

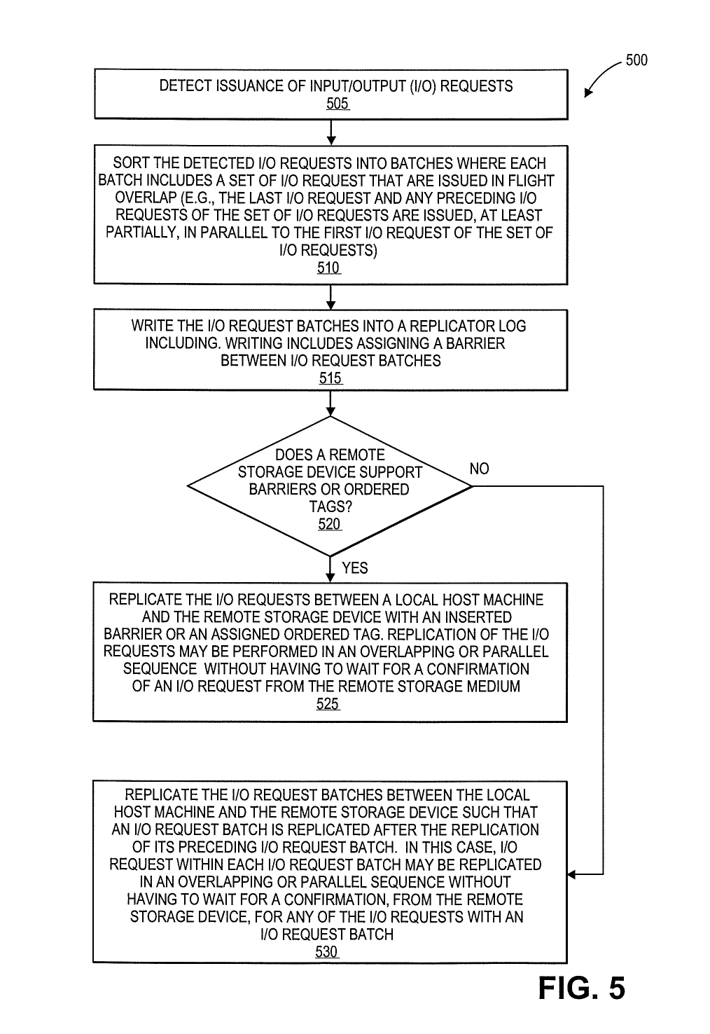

FIG. 5 illustrates a method for delayed replication according to one embodiment of the invention. Method 500 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 500 is performed by delayed replication mechanism of FIG. 1.

Method 500 starts with the delayed replication mechanism of a host machine detecting issuance of I/O requests by a software application running on the host machine at block 505. At block 510, the detected I/O requests are sorted into I/O batches. Each I/O batch includes a set of I/O requests that are flight-overlapped with the first I/O request serving at the primary I/O request. As aforementioned, flight overlap refers to the process of parallel issuance of I/O requests within an I/O batch, such as when the last I/O request and any preceding I/O requests have at least begin their issuance before the issuance process of the first I/O request of the I/O batch has ended. At block 515, the I/O requests of the sorted I/O batches are written into a replicator log. In one embodiment, a barrier identifying and representing the gap between two consecutive I/O batches is also noted in the replicator log.

At decision block 520, a determination is made as to whether a remote storage device supports inserted barrier requests and/or assigned ordered tags. At block 525, if the remote storage device supports inserted barrier requests and/or assigned ordered tags, I/O requests of I/O batches having inserted barrier requests and/or assigned ordered tags are replicated at the storage device having the ability to directly identify each distinct I/O batch by its corresponding barrier request or ordered tag. This replication of the I/O requests may be performed in a sequence that is independent of receiving confirmation responses form the storage device for any of the I/O requests. At block 530, if the remote storage device does not support barrier requests and/or ordered tags, I/O requests are replicated at the remote storage device in I/O batches as defined in the replication log. This replication is performed in a sequence where an I/O request within an I/O batch is replicated without having to wait for a confirmation response for any of the other I/O requests of the same I/O batch.

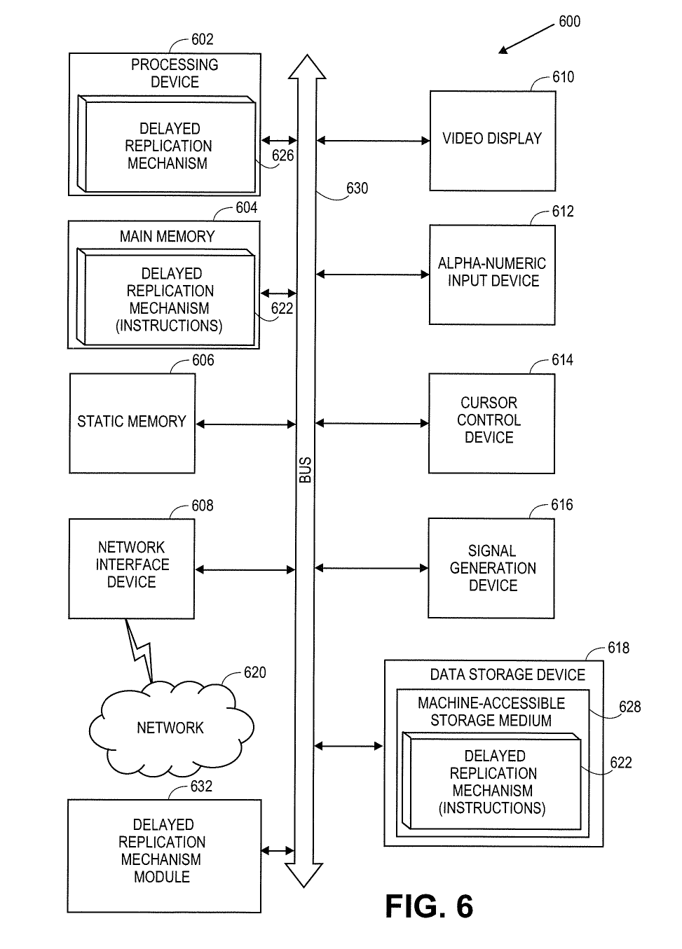

FIG. 6 illustrates a computing system 600 employing a delayed replication mechanism according to one embodiment of the invention. Within the computing system 600 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computing system 600 includes a processing device 602, a main memory 604 (e.g., read-only memory (ROM), flash memory, RAM, dynamic RAM (DRAM) such as synchronous DRAM (SDRAM), DRAM (RDRAM), etc.), a static memory 606 (e.g., flash memory, static random access memory (SRAM), etc.), and a secondary memory 618 (e.g., a data storage device in the form of a drive unit, which may include fixed or removable machine-accessible or computer-readable storage medium), which communicate with each other via a bus 630.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic 626 for performing the operations and methods discussed herein.

The computing system 600 may further include a network interface device 608. The computing system 600 also may include a video display unit 610 (e.g., a liquid crystal display (LCD) or a cathode ray tube (CRT)) connected to the computing system through a graphics port and graphics chipset, an alphanumeric input device 612 (e.g., a keyboard), a cursor control device 614 (e.g., a mouse), and a signal generation device 616 (e.g., a speaker).

The data storage device 618 may include a machine-accessible storage medium (or a computer-readable storage medium) 628 on which is stored one or more sets of instructions 622 (e.g., delayed replication mechanism) embodying any one or more of the methodologies or functions described herein. The delayed replication mechanism may also reside, completely or at least partially, within the main memory 604 (e.g., delayed replication mechanism (instructions) 622) and/or within the processing device 602 (e.g., delayed replication mechanism (processing logic) 626) during execution thereof by the computing system 600, the main memory 604 and the processing device 602 also constituting machine-readable storage media. Further, for example, the delayed replication mechanism instructions 622 may be transmitted or received over a network 620 via the network interface device 608.

The machine-readable storage medium 628 may also be used to store the delayed replication mechanism (instructions) 622 persistently. While the machine-accessible storage medium 628 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

Delayed replication mechanism modules 632, components and other features described herein (for example in relation to FIG. 1) can be implemented as discrete hardware components or integrated in the functionality of hardware components such as ASICS, FPGAs, DSPs or similar devices. In addition, the modules 632 can be implemented as firmware or functional circuitry within hardware devices. Further, the modules 632 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “detecting”, “sorting”, “replicating”, “registering”, “writing”, “noting”, “assigning”, “inserting”, “initiating”, “issuing”, “flight overlapping”, “committing”, “notifying”, “responding”, “performing”, “persisting”, “saving”, “storing”, “receiving”, “communicating”, “providing”, “facilitating” or the like, refer to the action and processes of a computing system, or similar electronic computing device, that manipulates and transforms data represented as physical (electronic) quantities within the computing system's registers and memories into other data similarly represented as physical quantities within the computing system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a machine readable storage medium, such as, but not limited to, any type of disk including floppy disks, optical disks, magnetic-optical disks, ROMs, compact disk ROMs (CD-ROMs), RAMs, erasable programmable ROMs (EPROMs), electrically EPROMs (EEPROMs), magnetic or optical cards, or any type of media suitable for storing electronic instructions, each coupled to a computing system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computing system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., ROM, RAM, magnetic disk storage media, optical storage media, flash memory devices, etc.), a machine (e.g., computer) readable transmission medium (non-propagating electrical, optical, or acoustical signals), etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A computer-implemented method comprising:
detecting input/output (I/O) requests issued by a software program running on a computer system;
sorting the I/O requests into I/O batches according to flight overlapping of the I/O requests, wherein an I/O batch includes a set of flight-overlapped I/O requests of the I/O requests, wherein the set of flight overlapped I/O requests includes two or more I/O requests that are issued, at least partially, in parallel; and
replicating the I/O requests to a storage medium coupled to the computer system.

2. The computer-implemented method of claim 1, wherein replicating comprises replicating each I/O request without receiving, from the storage medium, a confirmation response for a previously-replicated I/O request.

3. The computer-implemented method of claim 1, wherein replicating further comprises replicating each I/O request of an I/O batch without receiving, from the storage medium, a confirmation response for a previously-replicated I/O request of the I/O batch.

4. The computer-implemented method of claim 1, further comprising registering the I/O requests in a replication log, wherein registering includes assigning a barrier between consecutive I/O batches to distinguish each I/O batch from another according to the sorting of the I/O requests.

5. The computer-implemented method of claim 1, further comprising inserting a barrier request between each two consecutive I/O batches, and wherein replicating further comprises replicating I/O requests of the two consecutive I/O batches with inserted barrier requests to be identified by the storage medium.

6. The computer-implemented method of claim 1, further comprising assigning an ordered tag to a first I/O request or a last I/O request of each I/O batch, and wherein replicating further comprises replicating the I/O requests with assigned ordered tags to be identified by the storage medium.

7. The computer-implemented method of claim 6, wherein the storage medium comprises a remote storage device including a storage area network (SAN) device, a network-attached storage (NAS) device, or an Internet Small Computer System Interface (iSCSI).

8. A system comprising:
a host computing device having a memory to store instructions for delayed replication, and a processing device to execute the instructions, wherein the instructions cause the processing device to:
detect input/output (I/O) requests issued by a software program running on a computer system;
sort the I/O requests into I/O batches according to flight overlapping of the I/O requests, wherein an I/O batch includes a set of flight-overlapped I/O requests of the I/O requests, wherein the set of flight overlapped I/O requests includes two or more I/O requests that are issued, at least partially, in parallel; and
replicate the I/O requests to a storage medium coupled to the computer system.

9. The system of claim 8, wherein replicating comprises replicating each I/O request without receiving, from the storage medium, a confirmation response for a previously-replicated I/O request.

10. The system of claim 8, wherein replicating further comprises replicating each I/O request of an I/O batch without receiving, from the storage medium, a confirmation response for a previously-replicated I/O request of the I/O batch.

11. The system of claim 8, wherein the processing device is further to register the I/O requests in a replication log, wherein registering includes assigning a barrier between consecutive I/O batches to distinguish each I/O batch from another according to the sorting of the I/O requests.

12. The system of claim 8, wherein the processing device is further to insert a barrier request between each two consecutive I/O batches, and wherein replicating further comprises replicating I/O requests of the two consecutive I/O batches with inserted barrier requests to be identified by the storage medium.

13. The system of claim 8, wherein the processing device is further to assign an ordered tag to a first I/O request or a last I/O request of each I/O batch, and wherein replicating further comprises replicating the I/O requests with assigned ordered tags to be identified by the storage medium.

14. The system of claim 13, wherein the storage medium comprises a remote storage device including a storage area network (SAN) device, a network-attached storage (NAS) device, or an Internet Small Computer System Interface (iSCSI).

15. A machine-readable medium including instructions that, when executed by a processing device, cause the processing device to perform a method, the method comprising:
detecting input/output (I/O) requests issued by a software program running on a computer system;
sorting the I/O requests into I/O batches according to flight overlapping of the I/O requests, wherein an I/O batch includes a set of flight-overlapped I/O requests of the I/O requests, wherein the set of flight overlapped I/O requests includes two or more I/O requests that are issued, at least partially, in parallel; and
replicating the I/O requests to a storage medium coupled to the computer system.

16. The machine-readable medium of claim 15, wherein replicating comprises replicating each I/O request without receiving, from the storage medium, a confirmation response for a previously-replicated I/O request.

17. The machine-readable medium of claim 15, wherein replicating further comprises replicating each I/O request of an I/O batch without receiving, from the storage medium, a confirmation response for a previously-replicated I/O request of the I/O batch.

18. The machine-readable medium of claim 15, wherein the method further comprises registering the I/O requests in a replication log, wherein registering includes assigning a barrier between consecutive I/O batches to distinguish each I/O batch from another according to the sorting of the I/O requests.

19. The machine-readable medium of claim 15, wherein the method further comprises inserting a barrier request between each two consecutive I/O batches, and wherein replicating further comprises replicating I/O requests of the two consecutive I/O batches with inserted barrier requests to be identified by the storage medium.

20. The machine-readable medium of claim 15, wherein the method further comprises assigning an ordered tag to a first I/O request or a last I/O request of each I/O batch, and wherein replicating further comprises replicating the I/O requests with assigned ordered tags to be identified by the storage medium.
